(19) United States
(12) Patent Application Publication
(10) Pub. No.: US 2024/0339744 A1
(43) Pub. Date: Oct. 10, 2024

(54) Circulator Arrangement and Means of Construction for a Microwave Oven

(71) Applicant: TE Connectivity Nederland B.V., s'Hertogenbosch (NL)

(72) Inventor: Robin WESSON, 's-Hertogenbosch (NL)

(73) Assignee: TE Connectivity Nederland B.V., s'Hertogenbosch (NL)

(21) Appl. No.: 18/625,252

(22) Filed: Apr. 3, 2024

(30) Foreign Application Priority Data
Apr. 6, 2023 (EP) 23167093.6

(51) Int. Cl. H01P 1/38; H01P 3/08; H05B 6/72

(52) U.S. Cl. CPC H01P 1/38; H01P 3/08; H05B 6/72

(57) ABSTRACT

The document relates to a circulator forming an isolator for transmitting microwaves in one direction. The circulator comprises: a receiving port for receiving a high-power microwave beam generated by a solid state microwave source; a transceiver port for transmitting the high-power microwave beam to a microwave chamber and the transceiver port for receiving a reflected microwave beam from the microwave chamber; and a microwave absorber connected to a terminating port of the circulator, the microwave absorber for absorbing the reflected microwave beam received by the transceiver port. Further, the circulator comprises a heat sink thermally conductive coupled to the microwave absorber, the heat sink for transferring heat, which is generated by absorbing the microwave beam, to a fluid medium, wherein the heat sink is formed by a casing, the casing housing the circulator and the casing having a void for housing the solid state microwave source.

This application claims priority to and the benefit of EP Patent Application No. 23167093.6 filed Apr. 6, 2023, which is hereby incorporated by reference in its entirety.

The invention relates to a circulator, for example a terminated circulator, for a ‘solid state’ microwave oven typically forming an isolator for transmitting microwaves in one direction. Microwave ovens have traditionally used the magnetron to generate the required RF power but the Magnetron cannot be controlled digitally to provide the coherent phase controlled emissions necessary to control the hotspots and cold spots common in microwave cooking. Producing solid state amplifiers and control systems suitable for consumer volume applications requires significant cost reduction compared to traditional RF or Microwave amplifier markets.

The circulator is a passive, non-reciprocal three- or four-port device that only allows a microwave or radio-frequency signal (RF signal) to exit through the port directly after the one it entered. Ports are where an external waveguide or transmission line, such as a microstrip line or a coaxial cable, connects to the device. For a three-port circulator, a signal applied to port 1 only comes out of port 2; a signal applied to port 2 only comes out of port 3; a signal applied to port 3 only comes out of port 1, and so on. Microwave is a form of electromagnetic radiation with wavelengths ranging from about one meter to one millimeter corresponding to frequencies between 300 MHz and 300 GHz respectively. RF signals range from around 20 kHz to around 300 MHz. Microwave heating typically uses frequencies in the 2400-2500 MHz range but solid-state microwaves are able to operate at a wider range of frequencies including around 915 MHz and 433 MHz. This circulator arrangement and means of production is applicable to all.

An isolator is a two-port device that transmits microwave or radio frequency power in one direction only. The non-reciprocity observed in these devices usually comes from the interaction between the propagating wave and the material, which can be different with respect to the direction of propagation. It is used to shield the equipment on its input side, from the effects of conditions on its output side; for example, to prevent a microwave source from being detuned by a mismatched load.

In the field of solid state heating both the circulator and the closely related isolator are often used. The circulator can protect the amplifier from reflections from the heating cavity, while directing the reflected signals into a power measurement load subcircuit. This allows the system to assess the efficacy of the current mode of operation in terms of whether the energy is being reflected and wasted or is being used for heating. In other architectures, the circulator is paired only with a high power load hence absorbing all the reflected power. The circulator can be used in the isolator arrangement when there is no requirement for reflected power measurement or when there are other means provided for this function such a reflectometer. In both configurations, a circulator is required and this benefits from a lower cost arrangement and means of production.

A circulator forming a two-port isolator is obtained simply by terminating one of the three ports of the circulator with a microwave absorber, which absorbs all the power entering it. In more detail, when sending power down a transmission line, as much power as possible is absorbed by the microwave absorber (e.g. load to be heated) and as little as possible will be reflected back to the source. This can be ensured by making the load impedance of the microwave absorber equal to the characteristic impedance Z0, in which case the transmission line is said to be matched. Z0 is a single parameter called the characteristic impedance, which is used to describe the behavior of the transmission line. The characteristic impedance Z0 is determined by the geometry and materials of the transmission line and, for a uniform line, is not dependent on its length.

A transmission line as used here is a specialized cable or other structure designed to conduct electromagnetic waves in a contained manner. The term applies when the conductors are long enough that the wave nature of the transmission must be taken into account. This applies especially to microwaves and RF signals because the short wavelengths mean that wave phenomena arise over very short distances (this can be as short as millimeters depending on the frequency).

State of the art is that a typical microwave generator consists of a high-voltage magnetron that generates the microwaves. In view of the recent developments in the field of telecommunication, solid-state electronics have been developed which enable the generation of microwaves, hereinafter referred to as solid-state microwave sources. Solid-state electronics means semiconductor electronics: electronic equipment using semiconductor devices such as transistors, diodes and integrated circuits (ICs). The term is also used for devices in which semiconductor electronics that have no moving parts replace devices with moving parts.

In the case of a microwave source, solid-state electronics can be used as follows. A quartz crystal or other frequency reference imposes the frequency of the initial signal, which is converted to the final frequency by means of signal conversion techniques including the use of RF synthesizer techniques. The phase of the signal can be tuned by various means as known to those skilled in the art of RF system design. Finally the power of this initial signal is then considerably amplified by a series of transistor stages.

Such solid-state microwave sources have been realized for providing high power for communications, radar or scientific applications for many years. Only recently has such technology become suitable for high volume heating applications. Developments leading to the suitability include the power and efficiency of laterally diffused metal-oxide-semiconductor (LDMOS) RF and Microwave power transistors and the cost per watt of this technology. New semiconductor technologies such as Gallium Nitride promise to continue this long-term technology trend. As used herein, a high power solid-state microwave source generates a high-power microwave beam of more than 100 W. In particular, the high-power microwave beam ranges at frequencies between 500 MHz to 5 GHz. Thus, the microwave beam can be used to heat food. Typically solid state systems will combine power in a heating cavity from multiple channels providing enhanced scope for the system to control and modulate patterns of hot and cold spots in the food compared to the traditional methods using the Magnetron. The transition to solid state amplifiers brings the requirement for ‘mass market’ RF and microwave circulators, a trend which is further enhanced by the move to multiple channels per appliance, each of which requires a circulator or isolator.

The application of high-power microwave beams is particularly necessary in the field of broadcasting signals from a base station in telecommunications. The development of high-power microwave beams by solid-state electronics can be beneficial for other applications, especially in microwave ovens for microwave cooking. Alternative applications such as medical devices, which require a stable and narrow microwave signal, plasma generators with independently controlled plasma sources, or sensitive low pressure surface treatment applications are also possible.

As used herein, a microwave oven is an electric oven that heats and cooks food placed in a microwave chamber by exposing it to electromagnetic radiation in the microwave frequency range. This induces polar molecules in the food to rotate and produce thermal energy in a process known as dielectric heating. Microwave ovens heat food quickly and efficiently because excitation is fairly uniform in the outer 25-38 mm of a homogeneous, high-water-content food item. State of the art is that a magnetron generates the electromagnetic waves of a small enough wavelength (microwaves).

One danger of using microwave sources in a closed microwave chamber are reflections. For example, in the case of a microwave oven, if only a small amount of food (or no food) is placed in the chamber, the microwave beam cannot be (completely) absorbed, and thus, will be reflected back to the source. To protect the source, a circulator forming an isolator described above can be used.

Circulators, therefore, are expensive parts, and this cost can limit the growth of the new microwave cooking technology. For example, the materials for the magnet are expensive. Further, circulators are supplied as modular components, which require additional considerations in view of connecting the parts to the microwave source. This includes the application of solder and flux to the device, materials which can fail and lead to breakdown and arcing and ultimate destruction of the device in the field. Furthermore, the circulators which form an isolator must be constructed in such a way as to dissipate the heat which is made more challenging by the modular form factor in the state of the art.

The object of the invention is to provide a solution for a circulator or isolator, which allows for simple integration and streamlined production in a microwave heating apparatus such as a microwave oven. Further, the thermal management of the circulator or isolator has to be improved. Furthermore, since microwave ovens are mass products, the circulator or isolator has to be produced economically.

This object is solved by the independent claims. Advantageous embodiments are solved by the dependent claims.

According to a general aspect, a circulator, e.g. a terminated or unterminated circulator, comprises a casing, wherein the casing additionally comprises a void for housing a solid-state microwave source. Thus, the recently developed solid-state microwave sources and the circulator can be housed by using one casing, which reduces the total number of parts. This is possible because a transmission line of the circulator and semiconductor components of the solid-state microwave source can be both formed on a circuit board, for example one common circuit board.

In more detail, a first aspect relates to a circulator forming an isolator. The circulator enables to transmit microwaves in one direction. In particular, microwaves are transmitted by the isolator only from a source to an antenna and a path from the antenna to the source is isolated or blocked.

In more detail, the circulator has at least three ports. Ports are where an external transmission line, such as a microstrip line, a stripline, or a coaxial cable, connects to the circulator. Further, in the circulator, the ports of the circulator are connected by an internal transmission line, also referred to as internal transmission structure. As used herein, transmission lines are used for purposes such as connecting ports, radio sources, radio transmitters, radio receivers, and antennas. Transmission lines can be used to build circuits such as filters. These circuits, known as distributed-element circuits, are an alternative to traditional circuits using discrete capacitors and inductors.

In more detail, the transmission line is a specialized cable or other structure designed to conduct electromagnetic waves in a contained manner. The term applies when the conductors are long enough that the wave nature of the transmission must be taken into account. This applies especially to RF signals because the short wavelengths mean that wave phenomena arise over very short distances.

The distinguishing feature of most transmission lines is that they have uniform cross sectional dimensions along their length, giving them a uniform impedance, called the characteristic impedance Z0, to prevent reflections. Types of transmission line include parallel line (ladder line, twisted pair), coaxial cable, and planar transmission lines such as stripline and microstrip.

Further, a first port, which is referred to in the following as a receiving port, enables a high-power microwave signal generated by a solid-state microwave source to be received.

As described above, the solid-state microwave source comprises an oscillator unit for generating the RF signal and at least one amplifier formed by a semiconductor transistor for amplifying the RF signal. In more detail, the oscillator unit may be for example a crystal oscillator, which is an electronic oscillator circuit that uses a piezoelectric crystal as a frequency-selective element. RF synthesis techniques known to those skilled in the art of RF and Microwave system design can be used to translate the reference frequency to the final frequency needed for heating. Amplifiers, for example a series of transistor stages, then considerably amplify the power of the initial signal. In order to achieve a power of several kilowatts, it is possible to combine several semiconductor amplifiers until the desired power is obtained. An amplifier is an electronic device that can increase the power of a signal (a time-varying voltage or current). As discussed above, the high-power microwave beam has a power of more than 100 W. Depending on the frequency it is possible to generate a power of up to 2 kW by one solid-state microwave device. Further developments may enable even higher powers. Typical devices currently deliver 200-300 W at the frequency of operation of consumer microwaves today, around 2450 MHz.

In more detail, RF power amplifiers can use solid-state devices, predominantly MOSFETs (metal-oxide-semiconductor field-effect transistors). In particular, LDMOS (laterally-diffused metal-oxide semiconductor) transistors are used as the standard technology for RF power amplifiers due to the superior RF performance of LDMOS transistors. MOSFET transistors and other solid-state devices have replaced vacuum tubes in some electronic devices, but tubes are still used in some high-power transmitters, in particular in microwave ovens. Although mechanically robust, transistors are electrically fragile—they are easily damaged by excess voltage or current. Tubes are mechanically fragile but electrically robust—they can handle remarkably high electrical overloads without appreciable damage. Thus, in particular the application of a RF power amplifiers using solid-state devices is a challenge in microwave ovens in view of reflected signals.

Further, for RF signals, the semiconductor amplifiers are designed to attach to the transmission line at the input and output, ideally couple with an input or output impedance matched to the transmission line impedance. In other words, the semiconductor amplifiers are part of the transmission line.

Further, the circulator according to the first aspect comprises a second port, which is referred to as a transceiver port. The transceiver port is used for transmitting the high-power microwave beam via an antenna port to a microwave chamber by an antenna.

As used herein, an antenna is the interface between radio waves propagating through space and electric currents moving in the transmission line. In transmission, a radio transmitter supplies an electric current to the antenna's terminals, and the antenna radiates the energy from the current as electromagnetic waves (radio waves). In reception, the antenna intercepts some of the power of a radio wave and produces an electric current at its terminals, which is applied to a transmission line.

As used herein, a microwave chamber is for example the cooking chamber of a microwave oven. The microwave chamber can be similar to a Faraday cage to prevent the waves from leaving the chamber. Thus, an antenna port transmits and in turn receives a reflected microwave beam from the microwave chamber. In particular, in the case of for example a microwave oven, the microwave chamber forms a Faraday cage. The microwave oven can be empty, e.g. not having food absorbing the microwaves. In such a case, the complete power is reflected and the transceiver port receives the reflected microwave beam. In such a case, the reflected beam may have the same power as the high-power microwave beam. In other words, the transmission line receives the complete reflected power, which may be a danger for the semiconductor amplifiers.

Further, the circulator according to the first aspect comprises a third port, a terminating port. Further, the circulator comprises a microwave absorber (e.g. a load) connected to the terminating port. As described above, the microwave absorber (e.g. the load) enables the reflected microwave beam received by the transceiver port to be absorbed. In particular, the microwave absorber can absorb the reflected microwave beam by matching the impedance of the absorber to the impedance of the transmission line. In electronics, impedance matching is the practice of designing or adjusting the input impedance or output impedance of an electrical device for a desired value.

In particular, the impedance of an absorber transmission line connected to the terminating port is matched to the impedance of the internal transmission line, which is the transmission line in the circuit line. For example, the impedances can be matched by selecting a fitting geometry, e.g. the same cross section, and a fitting material, e.g. the same material.

Further, the circulator according to the first aspect comprises a heat sink, wherein the heat sink is thermally conductively coupled to the microwave absorber. Both the circulator body and the microwave load dissipate heat which must be in turn conducted away from the system to prevent destruction of the device and failure of the appliance. Thermal and electrical interfaces are eliminated in the solution disclosed and this increases reliability and performance while reducing cost. The heat sink is arranged for transferring heat, which is generated by absorbing the microwave signals, via the typically metal housings to a fluid medium such as air, water or other coolant.

As used herein, a heat sink is a passive heat exchanger that transfers the heat generated by absorbing the reflected microwave beam to a fluid, often air or a liquid coolant, where it is dissipated away from the circulator, thereby allowing regulation of the circulator. Heat sinks are used with high-power semiconductor devices such as power transistors used in the solid-state microwave sources and optoelectronics such as the oscillators, where the heat dissipation ability of the component itself is insufficient to moderate its temperature.

The heat sink is designed to maximize its surface area in contact with the cooling medium surrounding it, such as the air. For example, the heat sink comprises at least one protrusion, e.g. a heat fin. Air velocity, choice of material, protrusion design and surface treatment are factors that affect the performance of the heat sink. Further, the heat sink attachment methods and thermal interface materials also affect the die temperature of the integrated circuit. For example, a thermal adhesive or a thermal paste couples the microwave absorber to the heat sink to improve the heat sink's performance by filling air gaps between the heat sink and the microwave absorber of the circulator. The heat sink can comprise or consist of metals such as aluminum or copper.

Further, a casing forms the heat sink. A casing here is a covering that protects internal components. In this case, the casing protects the components forming the circulator, i.e. the internal transmission line and the absorber. In other words, the casing houses the circulator.

Further, the casing has a void to accommodate the above described solid-state microwave source. A void here is an empty space. In particular, the void is sufficiently large for receiving the components forming the solid-state microwave source.

The above configuration allows thermal control of a plurality of RF devices by one hardware component only, namely the thermal control of the circulator and an additional component, for example the solid-state microwave source. Further, the void allows a plurality of RF devices in one housing to integrate.

A second aspect, which is provided in addition to the first aspect, relates to an electric component comprising a circuit board, wherein the circulator is attached to the circuit board and the circuit board is held by the casing, the circuit board having a section for holding the solid-state microwave source.

A circuit board, also referred to as printed circuit board (PCB; also printed wiring board or PWB) is a medium to connect electronic components to one another in a controlled manner. It takes the form of a laminated sandwich structure of conductive and insulating layers: each of the conductive layers is designed with an artwork pattern of traces, planes and other features (similar to wires on a flat surface) etched from one or more sheet layers of copper laminated onto and/or between sheet layers of a non-conductive substrate. Electrical components may be fixed to conductive pads on the outer layers in the shape designed to accept the component's terminals, generally by means of soldering, to both electrically connect and mechanically fasten them to it.

The section for holding the solid-state microwave source is, for example, an area where the transistors of the amplifier are arranged. The above configuration with a circuit board allows an improved thermal control of the plurality of RF devices by one hardware component only, because the circuit board forms a common base so that the plurality of RF devices can be placed relative to the one casing. Further, having one circuit board reduces the number of parts, compared to the state of the art wherein the circulator or isolator ‘module’ contains a separate circuit substrate with connectivity to the terminals of the module which in turn must be connected to the first PCB.

A third aspect relates to the electric component according to the second aspect, wherein the circuit board comprises a circulator transmission line for conducing microwaves in the circulator.

Notably, transmission lines are more than simply interconnections. With simple interconnections, the propagation of the electromagnetic wave along the wire is fast enough to be considered instantaneous, and the voltages at each end of the wire can be considered identical. If the wire is longer than a large fraction of a wavelength (one tenth is often used as a rule of thumb), these assumptions are no longer true and transmission line theory must be used instead. With transmission lines, the geometry of the line is precisely controlled (in most cases, the cross-section is kept constant along the length) so that its electrical behavior is highly predictable. At lower frequencies, these considerations are only necessary for the cables connecting different pieces of equipment, but at microwave frequencies, the distance at which transmission line theory becomes necessary is measured in millimeters. Therefore, using transmission lines in a circuit board simplifies the design.

According to a fourth aspect, the casing according to any of the first to third aspects, houses two ferromagnetic discs. Optionally, the circuit board of the second aspect is arranged between the ferromagnetic discs thereby forming a ferrite circulator. For example, the casing has chambers for placing the ferromagnetic discs.

As used herein, a ferrite is a ceramic material made by mixing and firing large proportions of iron(III) oxide (Fe2O3, rust) blended with small proportions of one or more additional metallic elements, such as strontium, barium, manganese, nickel, and zinc. They are ferrimagnetic, which means they can be magnetized or attracted to a magnet. Unlike other ferromagnetic materials, most ferrites are not electrically conductive, making them useful in applications for ferrite circulators.

Ferrite circulators are radio-frequency circulators which employ magnetized microwave ferrite materials. They fall into two main classes: differential phase shift circulators and junction circulators, both of which are based on cancellation of waves propagating over two different paths in or near magnetized ferrite material. Waveguide circulators may be of either type, while more compact devices based on stripline are usually of the junction type. Two or more junction circulators can be combined in a single component to give four or more ports. Typically permanent magnets produce a static magnetic bias in the microwave ferrite material.

The above configuration with a chamber for holding the ferromagnetic discs allows an improved thermal control of the plurality of RF devices by one hardware component only, because the chambers for holding the ferromagnetic discs can be designed in view of the thermal requirements. Further, having chambers in the casing of the complete RF heating amplifier module for the ferromagnetic discs further reduces the number of parts in the system and reduces both the cost and the number of interfaces that can lead to failure.

According to a fifth aspect, the casing according to any of the first to fourth aspect, houses an electromagnet for generating a magnetic bias in a ferromagnetic disc of a ferrite circulator.

An electromagnet is a type of magnet in which the magnetic field is produced by an electric current. Electromagnets can consist of a wire wound into a coil. A current through the wire creates a magnetic field which is concentrated in the hole in the center of the coil. The magnetic field disappears when the current is turned off.

The above configuration with a chamber for holding the electromagnet allows an improved thermal control of the plurality of RF devices by one hardware component only, because the chambers for holding the electromagnet can be designed in view of the thermal requirements. Further, having chambers in the casing for the electromagnet reduces the number of parts. Further, the circuit board with the section for holding the solid-state microwave source has a power source which can be used to power the electromagnet. Further, an electromagnet may further reduce costs compared to using expensive permanent magnetic materials.

Advantageously, the electromagnet is controlled by a magnet circuitry formed on the circuit board and the magnet circuitry is thermally coupled to the heat sink. Thus, the thermal management can be further improved.

According to a sixth aspect, the electromagnet of the fifth aspect is formed by a coil, the coil being formed on the circuit board. In particular, the coil surrounds the circulator transmission.

Such a configuration is particularly space saving and a homogenous field inside the coil can be used for the circulator transmission line.

Advantageously, the current of the coil is controlled by a magnet circuitry formed on the circuit board and the magnet circuitry is thermally coupled to the heat sink. Thus, the thermal management can be further improved.

According to a seventh aspect, the casing according to any of the first to sixth aspect houses a solid-state microwave source. Preferably, the solid-state microwave source is arranged on the circuit board, the solid-state microwave source for generating the high-power microwave beam. For the description of the solid-state microwave source, reference is made to the above description with regard to the first aspect. In particular, the solid state microwave source comprises a semiconductor amplifier as described above, which is connected to the transmission line. Thus, the thermal management of the semiconductor amplifier can be further improved.

According to an eighth aspect, the circuit board according to any of the second to seventh aspects, comprises a high-power transmission line for conducting microwaves from a port of a solid-state microwave source to the receiving port of the circulator. For the description of a transmission line, refer to the above description. Advantageously, the high-power transmission line and the circulator transmission line according to the third aspect form together a continuous circuit board transmission line. Thus, the number of interconnections on the circuit board can be reduced.

According to a ninth aspect, the casing according to any of the first to eighth aspects houses a directional coupler connected between the transceiver port and an antenna port, the directional coupler to couple a defined amount of the electromagnetic power in a transceiver transmission line to a measurement port of the directional coupler for measuring the electromagnetic power transported through the transceiver transmission line by a sensor, the directional coupler being arranged on the circuit board.

Directional couplers are passive devices used mostly in the field of radio technology. They couple a defined amount of the electromagnetic power in a transmission line to a port enabling the signal to be used in another circuit, here a sensor circuit. An essential feature of directional couplers is that they only couple power flowing in one direction. Power entering the output port is coupled to the isolated port but not to the coupled port. Thus, it is possible to measure the power transmitted to the microwave chamber and/or the power reflected from the microwave chamber. In case of the reflected power being too high, the power generated by the solid-state microwave power may be reduced, for example, by operating the source in linear back-off or in pulsed mode. Thus, a directional coupler allows optimizing the overall thermal management.

Advantageously, the casing houses the power sensors, wherein each sensor is controlled by a senor circuitry formed on the circuit board and the sensor circuitry is thermally coupled to the heat sink. Thus, the overall thermal management can be further improved.

According to a tenth aspect, the circuit board according to any of the second to ninth aspects comprises a transceiver transmission line for conducing microwaves between the transceiver port of the circulator and an antenna port. For the description of a transmission line is referred to the above description. Advantageously, the transceiver transmission line and a circulator transmission line according to third aspect forming together a continuous circuit board transmission line. Thus, the number of interconnections on the circuit board can be reduced.

According to an eleventh aspect, relating to the electric component according to any of the third, eighth, and tenth aspects, wherein at least one of the circulator transmission line according to the third aspect, the high-power transmission line according to the eighth aspect, and the transceiver transmission line according to the tenth aspect is formed by a planar transmission line. In other words, the planar transmission line has, for example, a constant cross section.

Advantageously, the planar transmission line is a stripline or a microstrip.

A stripline circuit uses a flat strip of metal which is sandwiched between two parallel ground planes. The insulating material of the substrate forms a dielectric. The width of the strip, the thickness of the substrate and the relative permittivity of the substrate determine the characteristic impedance of the strip, which is a transmission line. The central conductor need not to be equally spaced between the ground planes. In the general case, the dielectric material may be different above and below the central conductor.

A microstrip is a type of electrical transmission line, which can be fabricated with any technology where a conductor is separated from a ground plane by a dielectric layer known as “substrate”.

Notably, the substrate can be provided by the circuit boards, and thus, the number of parts is further reduced.

A twelfth aspect, relates to the electric component according to third, eighth, tenth and eleventh aspects, wherein the circulator transmission line according to the third aspect, the high-power transmission line according to the eighth aspect, and the transceiver transmission line according to the tenth aspect together form a continuous circuit board transmission line. Thus, the number of interconnections can be reduced.

A thirteenth aspect relates to an electric component according to any of the eleventh or twelfth aspects, wherein the casing forms a ground plane for the transmission line. Thus, the components for the microstirp or the stripline can be reduced by using the casing as part of the transmission line.

A fourteenth aspect relates to an electric component according to any of the eleventh to thirteenth aspects, wherein the transmission line is sandwiched between a cover of the casing and a base of the casing, the cover and the base forming opposing ground planes of a stripline. Thus, the components for the stripline can be reduced by using the casing as part of the stripline.

The invention will now be described in greater detail and in an exemplary manner using advantageous aspects and with reference to the drawings. The described aspects are only possible configurations in which, however, the individual features as described above can be provided independently of one another or can be omitted.

The accompanying drawings are incorporated into the specification and form a part of the specification to illustrate several embodiments of the present invention. These drawings, together with the description serve to explain the principles of the invention. The drawings are merely for the purpose of illustrating the preferred and alternative examples of how the invention can be made and used, and are not to be construed as limiting the invention to only the illustrated and described embodiments. Furthermore, several aspects of the embodiments, individually or in different combinations, may form solutions according to the present invention. Thus, the embodiments described below may be considered either alone or in an arbitrary combination thereof. The described embodiments are merely possible configurations and it must be borne in mind that the individual features as described above can be provided independently of one another or can be omitted altogether while implementing this invention. Further features and advantages will become apparent from the following more detailed description of the various embodiments of the invention, as illustrated in the accompanying drawings, in which like references refer to like elements, and wherein:

In the figures,

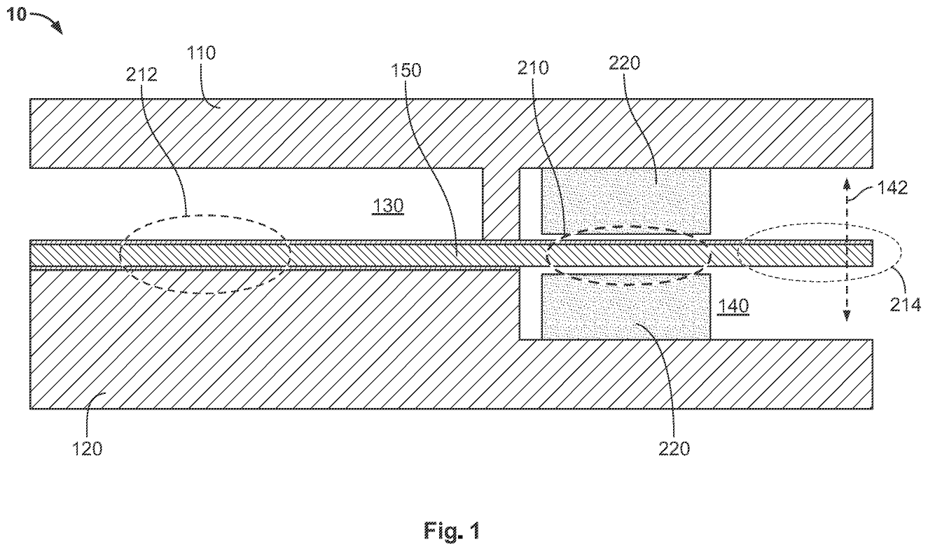

FIG. 1 is a schematic of an electric component according to a first aspect;

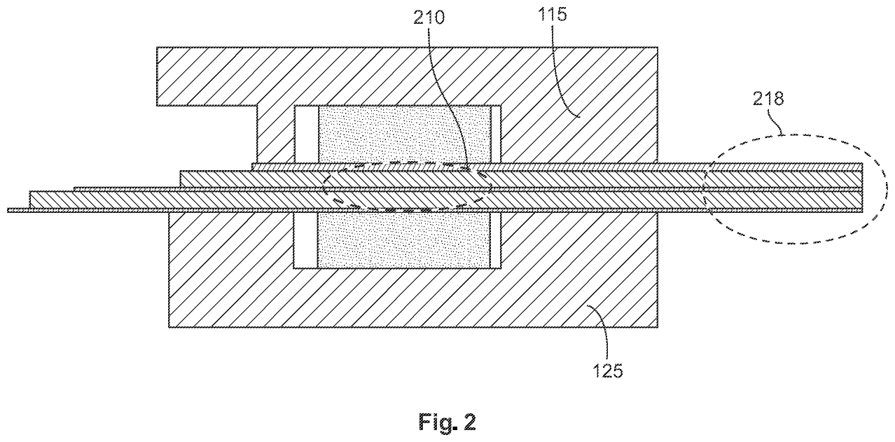

FIG. 2 is a schematic of an electric component according to a second aspect;

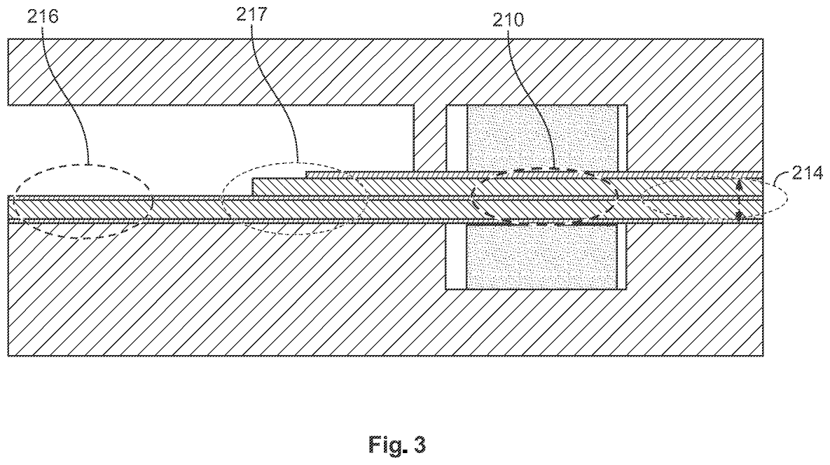

FIG. 3 is a schematic of an electric component according to a third aspect;

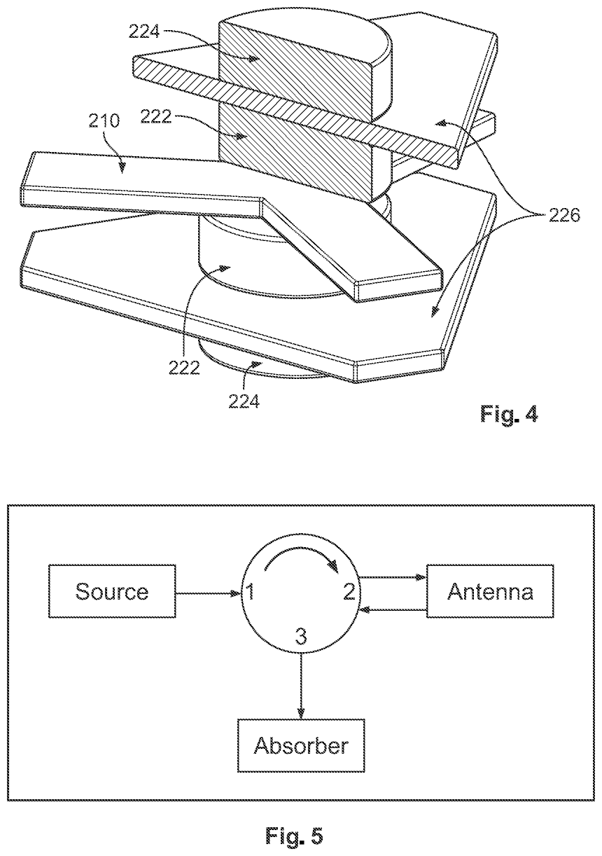

FIG. 4 is a perspective view of a circulator;

FIG. 5 is a functional block diagram of a circulator;

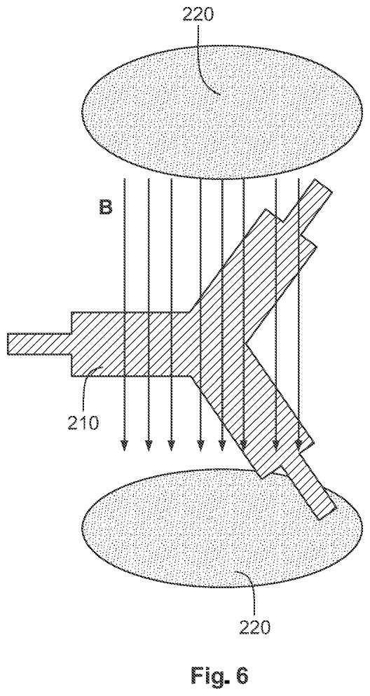

FIG. 6 is a schematic view of a circulator;

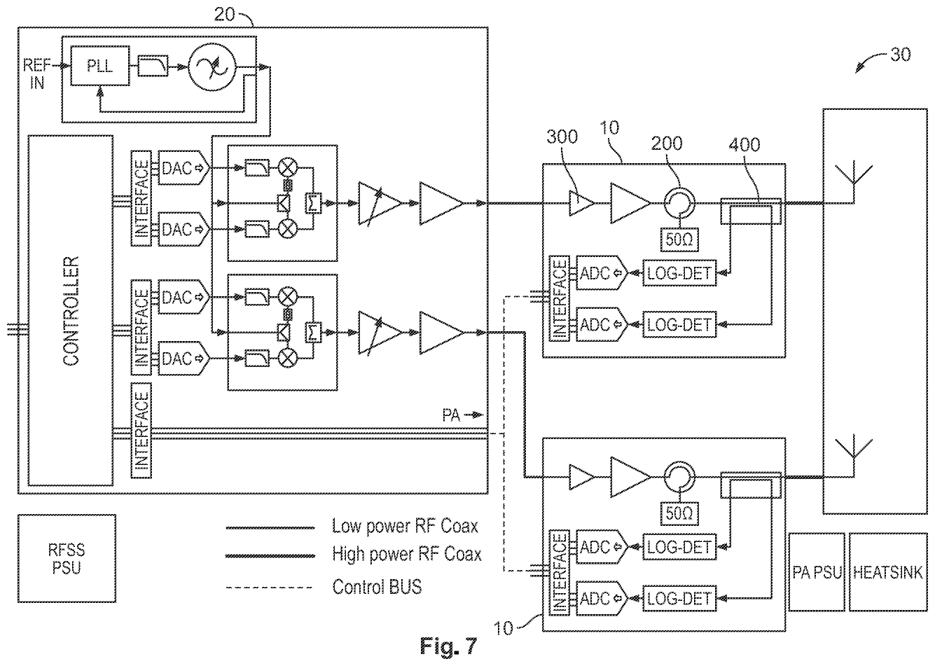

FIG. 7 is a circuit diagram according to a fourth aspect; and

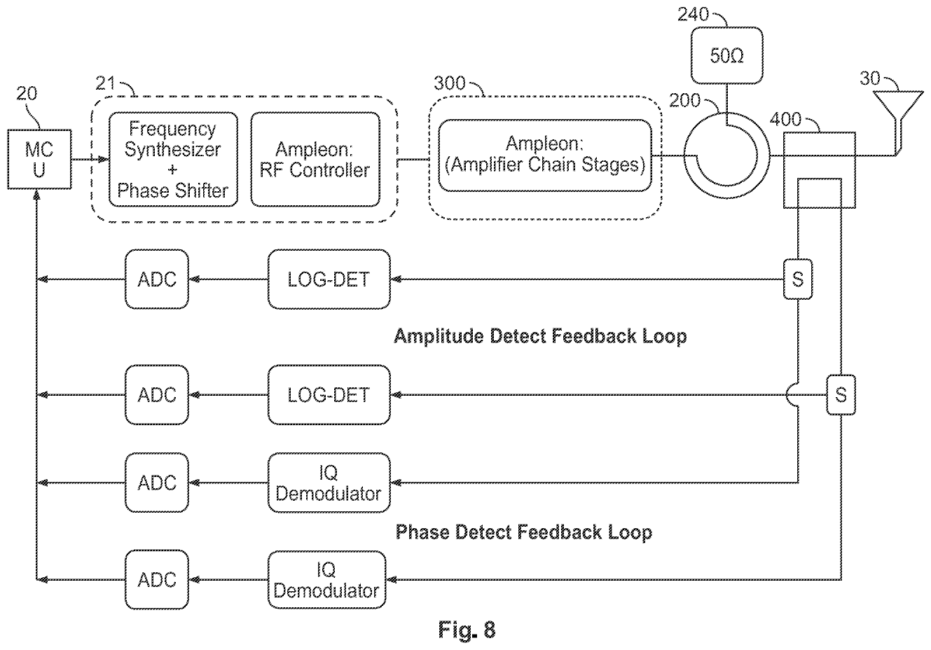

FIG. 8 is a functional block diagram according to a fifth aspect.

The present invention will now be explained in more detail with reference to the Figures. Referring to FIGS. 1 to 3, schematic diagrams of an electric component comprising a circulator 200 forming an isolator for transmitting microwaves in one direction are show.

Further, FIGS. 4 to 6 describe a circulator 200. In particular, as shown in FIG. 4, the circulator 200 comprises a circulator transmission line 210, which is also referred to as conductor, and ferromagnetic discs 222, wherein the transmission line 210 arranged between the ferromagnetic discs 222. Further, the circulator 200 comprises magnet elements 224, wherein the transmission line 210 and the ferromagnetic discs 222 are arranged between the magnet elements 224. Further, the circulator 200 can comprise ground plates 226 arranged between the magnet elements 224 and the ferromagnetic discs 222. The ground plates 226 for mounting the magnet arrangement comprising the magnet elements 224 and the ferromagnetic discs 222.

According to an example, at least one of the magnet elements 224 is a permanent magnet. Alternatively, at least one of the magnet elements 224 is an electromagnet, for example the both magnet elements 224 form a long solenoid. An electromagnet has the advantage that a circuit board is only modified minimal. Further, in case of the circuit board comprising further semiconductor elements, the circuit board already has a power circuit for powering the semiconductor elements, which can be thus used for the electromagnet. Further, the power circuit can vary the current through the electromagnet according to a load. Further, expensive ferrites may be avoided. Additionally, expensive permanent magnets are avoided.

Further, FIG. 5 describes the function of the circulator 200. A source generates a microwave beam. The circulator 200 has a receiving port 1 for receiving the high-power microwave beam generated by a source, wherein the source is in particular a solid-state microwave source.

The microwave beam is circulated to a transceiver port 2, which is connected to an antenna. The antenna is arranged for transmitting the high-power microwave beam to a not shown microwave chamber and the antenna is arranged for receiving a reflected microwave beam from the microwave chamber. Thus, the circulator 200 receives by transceiver port 2 the reflected microwave beam.

Further, the circulator 200 comprises a microwave absorber connected to a terminating port 3 of the circulator 200. The microwave absorber absorbs the reflected microwave beam received by the transceiver port 2.

Further, FIG. 6 describes how the circulator 200 operates. A magnet arrangement 220, for example comprising the ferromagnetic discs 222 and the magnet elements 224 of FIG. 3, generates a static magnetic field B that is concentrated into a nearly uniform field in the circulator transmission line 210. Thus, the magnetic field B allows that the microwave or radio-frequency signal exits only through the port directly after the one it entered.

According to an alternative, not shown in the figures, a circuit board holding the transmission line 210 comprises a coil for forming the electromagnet. Such an arrangement eliminates transitions, which can burn at high power and high reflection conditions. For the further operation of the circulator and the absorber, it is referred to the above description.

Back to FIGS. 1 to 3, the electric component 10 is described in more detail. In particular, the electric component 10 comprises a casing formed by a cover 110 and a base 120.

The circulator transmission line 210 is sandwiched between the cover 110 of the casing and the base 120 of the casing. In particular, the circulator transmission line 210 can be formed as a part of a circuit board 150. In other words, the circuit board 150 comprises the circulator transmission line 210 for conducing microwaves in the circulator.

Further, the casing forms a void 130 and a chamber 140. The void 130 can house a not shown solid-state microwave source. For the description of the solid-state microwave source is referred to the above. In particular, not shown transistors for an amplifier can be arranged in the void 130. For example, the circuit board 150 has a section 212 for holding the solid state microwave source. In particular, the solid state microwave source is arranged on the circuit board 150, namely in the section 212. The section 212 is in thermal contact with the base 120 of the casing, and thus, the thermal management of the solid-state microwave source can be improved. Not shown is that the solid state microwave source is controlled by an emitter circuitry formed on the circuit board 150, for example in the section 212, and the emitter circuitry is thermally coupled to the base 120.

Further, the casing is a heat sink thermally conductive coupled to a not shown microwave absorber. For the description of the heat sink, it is referred to the above. In particular, the casing may comprise or may consist of aluminum. Thus, the casing forming the heat sink can transfer heat, which is generated by absorbing the microwave beam by the absorber, to a fluid medium. Further, the casing houses in the chamber 140 the terminated circulator and the casing has the void 130 for housing the not shown solid state microwave source.

In more detail, the chamber 140 houses the circulator. The circulator comprises the transmission line 210 and may comprise a magnet arrangement 220. Further, the chamber 140 may comprise a front end void part 142 for further semiconductor devices such as a directional coupler.

With regard to the magnet arrangement 220, it is referred to the above description in view of FIGS. 4 to 6. In particular, the casing can house two ferromagnetic discs, which are part of the magnet arrangement 220, and the circuit board 150 is arranged between the ferromagnetic discs thereby forming a ferrite circulator. Further, the casing can house an electromagnet or a permanent magnet, which can be part of the magnet arrangement 220. The electromagnet or the permanent magnet can generate a magnetic bias in a ferromagnetic disc, which is an optional part of the magnet arrangement 220. Even not shown with regard to the Figures, the electromagnet can be controlled by a magnet circuitry formed on the circuit board 150. In particular, the magnet circuitry can be thermally coupled to the casing.

Additionally (or as an alternative for a permanent magnet or electromagnet arranged in the magnet arrangement 220) the circulator can comprise a coil that forms the electromagnet or a part of the magnet arrangement. In particular, the coil can be formed on the circuit board 150 surrounding the circulator transmission line 210. This is a particular save spacing arrangement.

As further shown in FIG. 1, the circuit board 150 comprises a high-power transmission line for conducting microwaves from a port of a solid state microwave source, i.e. an end of section 212, to the receiving port of the circulator, i.e. an end of section 210. As shown in FIG. 1, the high-power transmission line and the circulator transmission line 210 form together a continuous circuit board transmission line, which is realized by the circuit board 150.

As further shown in FIG. 1, the casing can house in the chamber 140 a directional coupler in a front end void part 142. The directional coupler is connected between the transceiver port and a not shown antenna port. The directional coupler, which has been described above, enables to couple a defined amount of the electromagnetic power in a transceiver transmission line 214 to a measurement port of the directional coupler for measuring the electromagnetic power transported through the transceiver transmission line 214 by a not shown sensor. The directional coupler can be arranged on the circuit board 150. Advantageously, the chamber 140 of the casing houses the sensor, wherein the sensor is controlled by a sensor circuitry formed on the circuit board 150 and the sensor circuitry is thermally coupled to the casing forming the heat sink. In FIG. 1, the transceiver transmission line 214 to the coupler is for example realized as a pseudo-stripline structure.

Further, as shown in FIG. 1, the circuit board 150 comprises the transceiver transmission line 214 for conducing microwaves between the transceiver port of the circulator and an antenna port. In particular, a continuous circuit board transmission line forms the transceiver transmission line 214 and the circulator transmission line 210.

As shown in FIG. 1, the circulator transmission line 210, the high-power transmission line 212, and the transceiver transmission line 214 are formed by a planar transmission line. According to the embodiment of FIG. 1, the planar transmission line is at least in part a microstrip or a pseudo-stripline.

Alternatively, as shown in FIG. 2, the circulator transmission line 210 can be a stripline. Further, in the aspect of FIG. 2, the transmission line can extend into a not shown antenna. In particular, the transmission line comprises an antenna transmission line 218, which is formed as a part of the circuit board.

According to the embodiment of FIG. 3, the transmission line can have a microstrip section 216 and a stripline section, which is for example the circulator transmission line 210. The both sections 216 and 210 can be connected by a transition section 217. In particular, the circulator transmission line 210 can be realized by a stripline, because magnetism goes through copper, which may be the ground plane of the stripline. The copper layer may be a layer provided by the circuit board.

Further, side walls 115 and 125 of the casing can abut to a transceiver transmission line 214. Such an arrangement is particularly advantageous for the thermal management.

As shown in above FIGS. 1 to 3, the circulator transmission line 210, the high-power transmission line, the transceiver transmission line 214, and the antenna transmission line 219 forming together a continuous circuit board transmission line in the circuit board. Notably, the transition sections, e.g. transition section 217, may be realized between the individual transmission lines.

Even not shown with the FIGS. 1 to 3, the casing, either the base or the cover, can form a ground plane for the transmission line. Thus, a microstrip can be efficiently realized. In particular, the base and the cover can form opposing ground planes for the transmission lines. Thus, a stripline can be efficiently realized.

Further, FIG. 7 shows a circuit diagram. In particular, low power transmission lines connect a control unit 20 to a plurality of electronic components 10. Further, high power transmission lines connect the electronic components 10 to antennas of an antenna array 30. The control unit 20 can comprise the oscillating unit.

Each of the electronic components 10 comprises semiconductor amplifiers 300, the circulator 200, the microwave absorber 240, and the directional coupler 400. For a description of these components is referred to the above.

Further, FIG. 8 is a functional block diagram. In particular, the control unit 20 controls an oscillator unit 21. Thus, an RF signal is generated, wherein at least one of a phase and a frequency of the RF signal can be controlled by the control unit 20.

The RF signal is transmitted to the amplifier 300. The amplifier 300 amplifies the signal. In particular, the amplifier are semiconductor devices on a circuit board, e.g. the circuit board 150 described in above FIGS. 1 to 3.

The amplified signal is passed via the circulator 200 and the directional coupler 400 to the antenna 30. In particular, the circulator 200 and the microwave absorber 240 are housed by a casing forming a heat sink, the casing having a void for receiving the amplifier 300. Further the casing may receive the amplifier 300 and the directional coupler. In particular, the circulator is the circulator described in above FIGS. 1 to 3.

Further, as shown in FIG. 7, the directional coupler sense the amplitude and the phase of the microwave beam exchanged between the circulator 200 and the antenna 30. The sensed values are feedback to the control unit 20.

REFERENCE NUMERALS

| Reference | |
|---|---|
| Numeral | Description |
| 1 | receiving port |
| 2 | transceiver port |
| 3 | terminating port |
| 10 | electric component |
| 20 | control unit |
| 21 | oscillator unit |
| 30 | antenna array |
| 110 | cover |
| 115, 125 | side walls |
| 120 | base |
| 130 | void |
| 140 | chamber |
| 142 | front end void part |
| 150 | circuit board |
| 200 | circulator |
| 210 | circulator transmission line |
| 212 | section for holding a solid-state microwave source |
| 214 | transceiver transmission line |
| 216 | microstrip section |
| 217 | transition section |
| 218 | antenna transmission line |
| 220 | magnet arrangement |
| 222 | ferromagnetic discs |
| 224 | magnet elements |
| 226 | ground plates |
| 240 | microwave absorber |
| 300 | amplifier |
| 400 | directional coupler |
| B | static magnetic field |

1. A circulator forming an isolator for transmitting microwaves in one direction, wherein the circulator comprises:
a receiving port for receiving a high-power microwave beam generated by a solid state microwave source;
a transceiver port for transmitting the high-power microwave beam to a microwave chamber and the transceiver port for receiving a reflected microwave beam from the microwave chamber;
a microwave absorber connected to a terminating port of the circulator, the microwave absorber for absorbing the reflected microwave beam received by the transceiver port; and
a heat sink thermally conductive coupled to the microwave absorber, the heat sink for transferring heat, which is generated by absorbing the microwave beam, to a fluid medium,
wherein the heat sink is formed by a casing, the casing housing the circulator and the casing having a void for housing the solid state microwave source.

2. An electric component comprising the circulator according to claim 1 and a circuit board, wherein the circulator is attached to the circuit board and the circuit board is held by the casing, the circuit board having a section for holding the solid state microwave source.

3. The electric component according to claim 2, wherein the circuit board comprises a circulator transmission line for conducing microwaves in the circulator.

4. The electric component according to claim 2, wherein the casing houses two ferromagnetic discs and the circuit board is arranged between the ferromagnetic discs thereby forming a ferrite circulator.

5. The electric component according to claim 2, wherein the casing houses an electromagnet for generating a magnetic bias in a ferromagnetic disc of a ferrite circulator, optionally wherein the electromagnet is controlled by a magnet circuitry formed on the circuit board and the magnet circuitry is thermally coupled to the heat sink.

6. The electric component according to claim 5, wherein a coil forms the electromagnet, the coil being formed on the circuit board, optionally wherein the current of the coil is controlled by a magnet circuitry formed on the circuit board and the magnet circuitry is thermally coupled to the heat sink.

7. The electric component comprising according to claim 2, wherein the casing houses a solid state microwave source arranged on the circuit board, the solid state microwave source for generating the high-power microwave beam.

8. The electric component according to claim 2, wherein the circuit board comprises a high-power transmission for conducting microwaves from a port of a solid state microwave source to the receiving port of the circulator.

9. The electric component according to claim 3, wherein, a high-power transmission for conducting microwaves from a port of a solid state microwave source to the receiving port of the circulator and the circulator transmission line forming together a continuous circuit board transmission line.

10. The electric component comprising according to claim 2, wherein the casing houses a directional coupler connected between the transceiver port and an antenna port, the directional coupler to couple a defined amount of the electromagnetic power in a transceiver transmission line to a measurement port of the directional coupler for measuring the electromagnetic power transported through the transceiver transmission line by a sensor, the directional coupler being arranged on the circuit board, optionally wherein the casing houses the sensor, wherein the sensor is controlled by a sensor circuitry formed on the circuit board and the sensor circuitry is thermally coupled to the heat sink.

11. The electric component according to claim 2, wherein the circuit board comprises a transceiver transmission line for conducing microwaves between the transceiver port of the circulator and an antenna port.

12. The electric component according to claim 3, wherein the circuit board comprises a transceiver transmission line for conducing microwaves between the transceiver port of the circulator and an antenna port, the transceiver transmission line and the circulator transmission line forming together a continuous circuit board transmission line.

13. The electric component according to claim 12, wherein at least one of (i) a circulator transmission line for conducing microwaves in the circulator of the circuit board, (ii) a high-power transmission for conducting microwaves from a port of a solid state microwave source to the receiving port of the circulator of the circuit board, or (iii) the transceiver transmission line is formed by a planar transmission line.

14. The electric component according to claim 13, wherein the planar transmission line is a stripline or a microstrip.

15. The electric component according to claim 12, wherein (i) a circulator transmission line for conducing microwaves in the circulator of the circuit board, (ii) a high-power transmission for conducting microwaves from a port of a solid state microwave source to the receiving port of the circulator of the circuit board, and (iii) the transceiver transmission line forming together a continuous circuit board transmission line.

16. The electric component according to claim 13, wherein the casing forms a ground plane for the transmission line.

17. The electric component according to claim 15, wherein the casing forms a ground plane for the transmission line.

18. The electric component according to claim 16, wherein the transmission line is sandwiched between a cover of the casing and a base of the casing, the cover and the base forming opposing ground planes of a stripline.

19. The electric component according to claim 17, wherein the transmission line is sandwiched between a cover of the casing and a base of the casing, the cover and the base forming opposing ground planes of a stripline.

20. The electric component according to claim 2, wherein the microwave source is adapted for generating microwaves having a frequency of more than 0.5 GHz and less than 5 GHz.
